(19) United States
(12) Patent Application Publication
(10) Pub. No.: US 2017/0367363 A1
(43) Pub. Date: Dec. 28, 2017

(54) MILK CONCENTRATES WITH IMPROVED MOUTH FEEL

(71) Applicant: NESTEC S.A., Vevey (CH)

(72) Inventors: Markus Kreuss, Freimettigen (CH); Nicole Rohrer, Reichenbach (CH); Christophe Joseph Etienne Schmitt, Servion (CH); Eric Kolodziejczyk, Vevey (CH); Madansinh Nathusinh Vaghela, Bakersfield, CA (US)

(21) Appl. No.: 15/538,135

(22) PCT Filed: Dec. 21, 2015
(86) PCT No.: PCT/EP2015/080845

§ 371 Date: Jun. 20, 2017

(30) Foreign Application Priority Data
Dec. 22, 2014 (EP) 14199613.2

(51) Int. Cl. A23C 9/15; A23J 1/20; A23C 9/154; A23J 3/10

(52) U.S. Cl. CPC A23C 9/1512; A23J 3/10; A23J 1/207; A23C 9/1542; A23V 2002/00; A23V 2200/254

(57) ABSTRACT

The present invention relates to a milk concentrate comprising caseins and whey proteins in the ratio of 90:10 to 60:40, wherein the caseins/whey protein aggregates have a volume based mean diameter value Dv50 of at least 1 μm as measured by laser diffraction. The invention also relates to a process for preparing a milk concentrate comprising the steps of providing a liquid milk concentrate, adjusting pH to 5.7-6.4, heat treating for 3-300 s at 80-150° C. and cooling to <70° C. Also, the use of the milk concentrate for producing a ready-to-drink beverage, culinary sauces and concentrated milk concentrates is described.

### FIELD OF THE INVENTION

The present invention relates to milk concentrates.

In particular, the invention is concerned with milk concentrate compositions comprising a protein complex which contributes to the improvement of creaminess, mouthfeel and texture, in particular of products based on lower and no fat formulations. A method of producing such milk concentrate products and the products obtainable from the method are also part of the present invention.

### BACKGROUND

Mouthfeel and creaminess as well as reduction of fat are key drivers of liking for milk based products such as coffee mixes, coffee enhancers businesses as well as a high number of other products.

Today, there is a challenge to increase the mouthfeel/creaminess of present milk concentrates and the objective of the present invention is to use all-natural formulation or ideally by the product matrix itself, instead of adding ingredients to the product, particularly in low and no fat products.

It is known since 1980's that a slight pH adjustment of native fresh milk prior to heat treatment results in change of aggregation behavior between casein micelles and whey proteins. However, the pH range that was explored in milk never went down lower than pH 6.3 [F. Guyomarc'h. 2006. Formation of heat-induced protein aggregates in milk as a means to recover the whey protein fraction in cheese manufacture, and potential of heat-treating milk at alkaline pH values in order to keep its rennet coagulation properties. A review. Lait, 86, 1-20].

It was surprisingly found that by mild acidification in the area of pH 5.7-6.4, the whey proteins in combination of controlled heat treatment form complexes with the casein micelles, which results in increased colloidal particle size and overall viscosity.

Adding thickeners (hydrocolloids, starches, etc.) has shown no big success due to unexpected texture change and flavor loss, increased length of ingredient list and also increases formulation costs.

Thus it is object of the present invention to improve mouthfeel/texture/thickness/creaminess of the current products, particularly with lower or no fat, in the market. It is also an object of the present invention to keep mouthfeel/texture/thickness/creaminess of a product constant while reducing fat content. Furthermore it is also object of the present invention to keep mouthfeel/texture/thickness/creaminess of a product constant while reducing thickening agents/stabilizers, e.g. hydrocolloids or starch.

### SUMMARY OF THE INVENTION

The present invention relates to a milk concentrate comprising caseins and whey proteins in the ratio of 90:10 to 60:40, wherein the caseins/whey protein aggregates have a volume based mean diameter value Dv50 of at least 1 μm as measured by laser diffraction.

Another aspect of the present invention relates to a process for preparing a milk concentrate comprising the steps of:
a) Providing a liquid milk concentrate at temperature below 25° C.;
b) Adjusting pH between 5.7 and 6.4;
c) Heat treating the composition at 80-150° C. for 3 to 300 seconds so that the milk concentrate comprises particles having a mean diameter value Dv50 of at least 1 μm as measured by laser diffraction. The mean diameter Dv50 ranges from 1 μm-60 μm;
d) Cooling the composition below 70° C. preferably below 60° C.

The present invention also relates to use of the milk concentrate for producing a ready-to-drink beverage, culinary sauces and dairy component in beverage system such as a beverage vending system.

Another aspect of the present invention relates to a process for preparing a milk concentrate comprising the steps of:
a) Providing a liquid milk concentrate at temperature below 25° C.;
b) Adjusting pH between 5.7 and 6.4;
c) Heat treating the composition at 80-150° C. for 3 to 300 seconds so that the milk concentrate comprises particles having a mean diameter value Dv50 of at least 1 μm as measured by laser diffraction. The mean diameter Dv50 ranges from 1 μm-60 μm;
d) Cooling the composition below 70° C. preferably below 60° C.

Wherein the process comprises further the steps of:
Readjusting the pH of the composition obtained from step c or d to a pH ranging above 6.4 to 6.8 and heat treating at UHT conditions or retort the product.

### DESCRIPTION OF THE FIGURES

FIG. 1 shows microscopic images of full fat milk concentrates in differential interference contrast (DIC) mode. A: Reference 1 and B: sample 1 of present invention (refer example 1 below). Sample of present invention shows controlled aggregate formation which is a microscopy signature of protein complex formation at molecular scale. The reference sample exhibits isolated round particles. Scale bar is 20 microns.

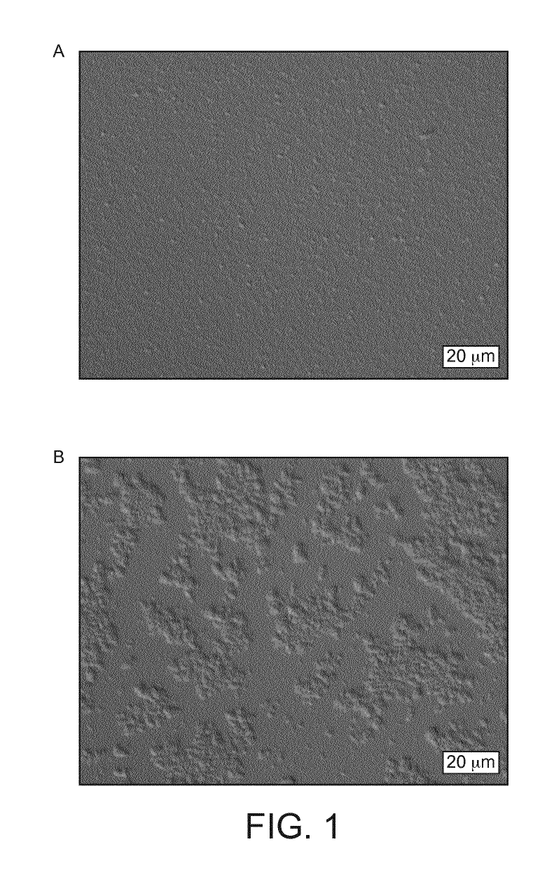

FIG. 2 shows microscopic images of skim milk concentrates in differential interference contrast (DIC) mode. A: Reference 2 and B: sample 2 of present invention (refer example 1 below). Sample of present invention shows controlled aggregate formation which is a microscopy signature of protein complex formation at molecular scale. The reference sample exhibits isolated round particles. Scale bar is 20 microns.

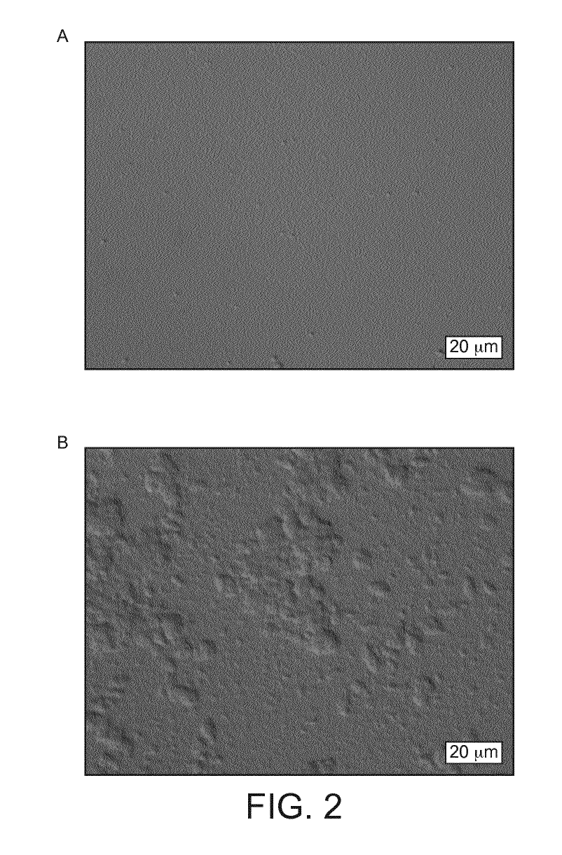

FIG. 3 shows particle size distributions of full fat milk concentrates at a total solids concentration of 35% (w/w). A: Reference 1 and B: sample 1 of present invention. Sample of present invention shows a particle size distribution exhibiting particle size around 6 μm whereas the reference sample is characterized by mostly 0.25 μm particles.

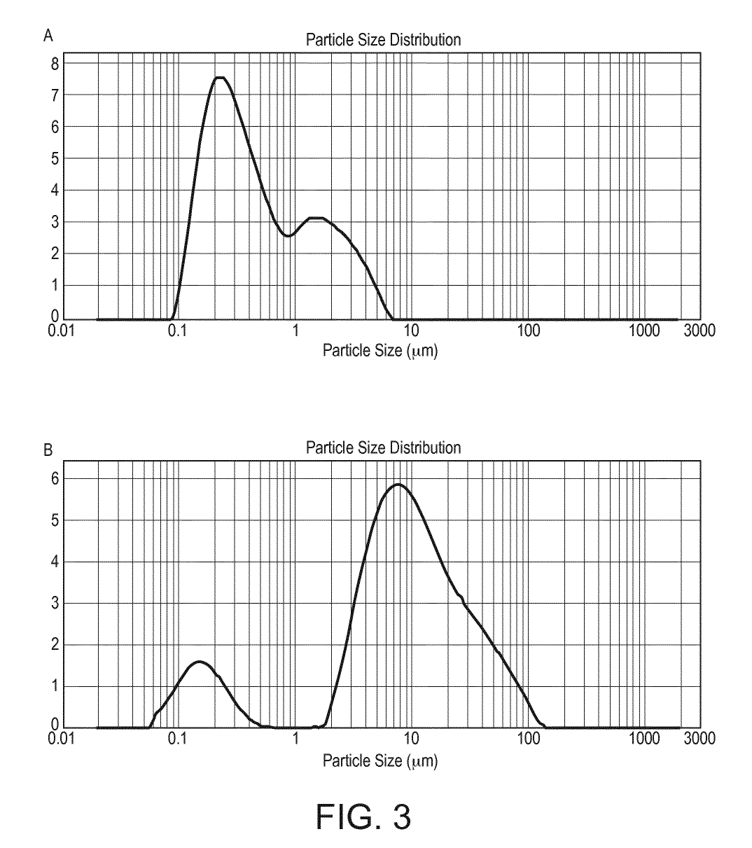

FIG. 4 shows particle size distributions of skim milk concentrates at a total solids concentration of 50% (w/w). A: Reference 2 and B: sample 2 of present invention. Sample of present invention shows a particle size distribution exhibiting particle size around 10 μm whereas the reference sample is characterized by mostly 0.15 μm particles.

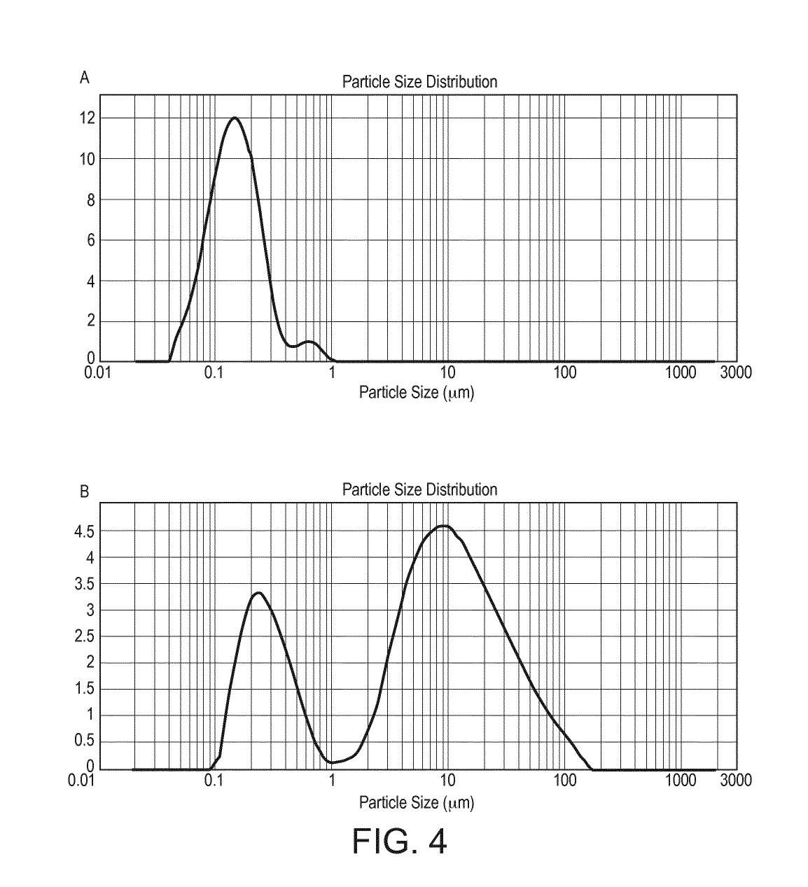

FIG. 5 shows flow curves obtained on skim milk concentrates at a total solids concentration of 50% (w/w). The critical viscosity values corresponding to a shear stress of 10 Pa and a shear rate of 100 l/s are indicated on the charts. A: Reference 2 and B: sample 2 of present invention. From the flow curves, it could be determined that the skim milk concentrate exhibited a shear viscosity of 167 mPa·s at a shear stress of 10 Pa and a shear viscosity of 109 mPa·s at a shear rate of 100 l/s. The viscosity ratio was 1.5. For the product of the invention, it was determined that the skim milk concentrate exhibited a shear viscosity of 13059 mPa·s at a shear stress of 10 Pa and a shear viscosity of 3355 mPa·s at a shear rate of 100 l/s. The viscosity ratio was thus 3.9.

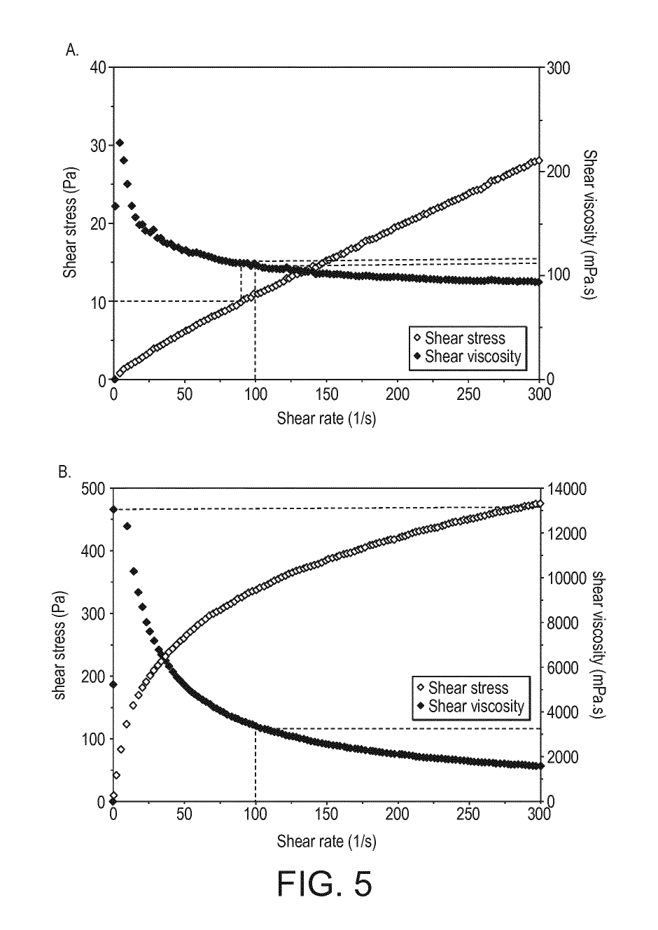

FIG. 6 shows particle size distributions of whole milk concentrate at a total solids concentration of 13, 25 and 37% (w/w) before the invention is carried out. Most of the particles are characterized by a Dv50 between 0.5 and 0.6 micron.

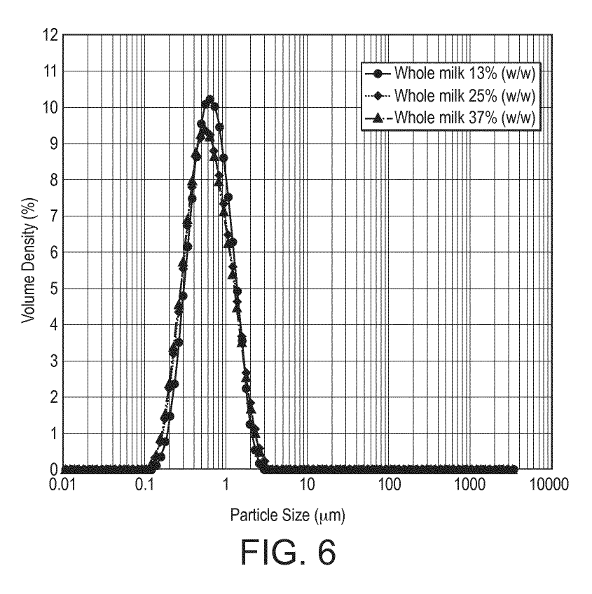

FIG. 7 shows particle size distribution of sample 4 of the present invention. Most of the particles are characterized by a Dv50 about 11 microns.

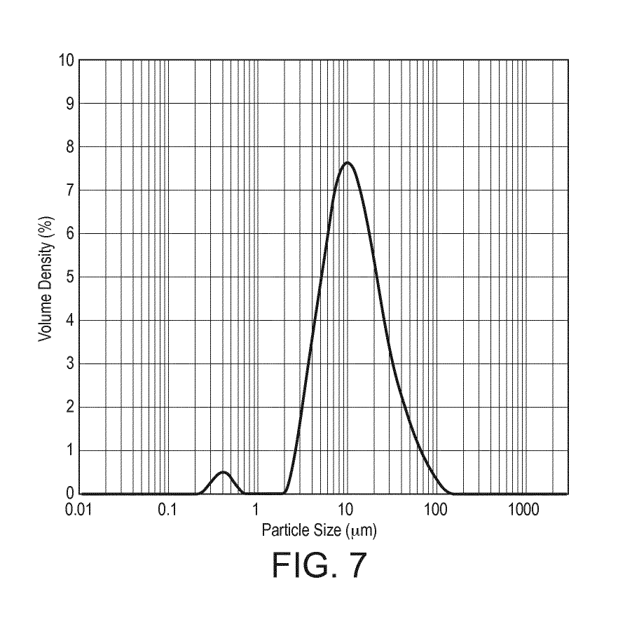

FIG. 8 shows particle size distribution of sample 6 of the present invention. Most of the particles are characterized by a Dv50 about 10 microns.

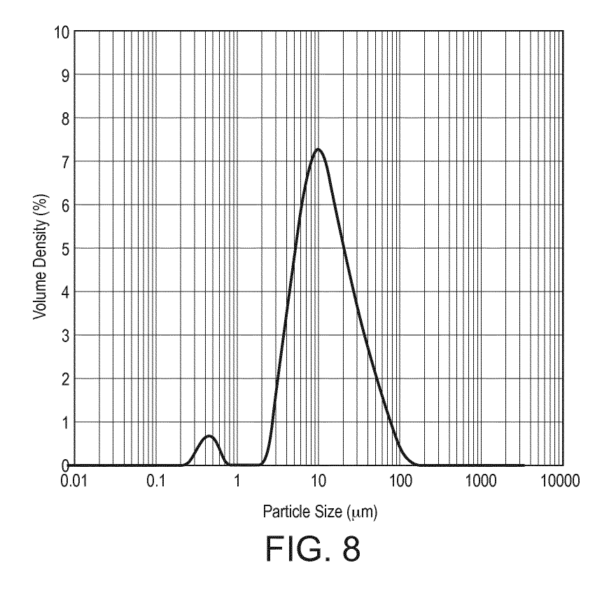

FIG. 9 shows the flow curves of whole milk concentrate at a total solids of 13, 25 and 37% (w/w) measured at 20° C.

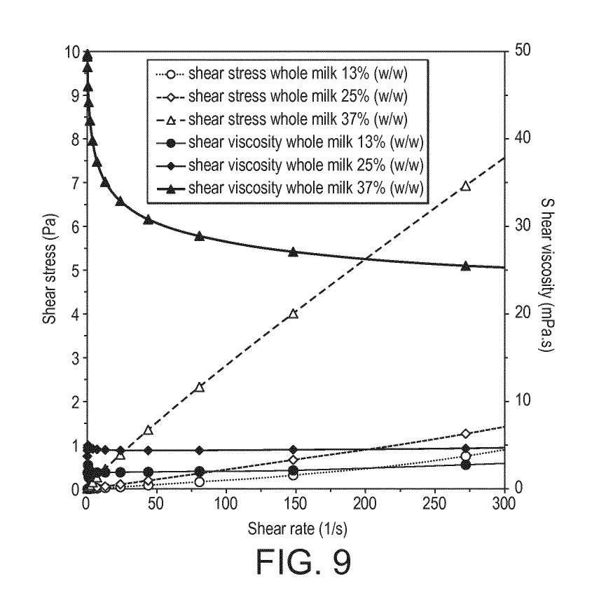

FIG. 10 shows the flow curves of sample 3 (A) and sample 6 (B) of the present invention measured at 20° C. When compared to whole milk samples not having been submitted to the invention, it can be seen that the viscosity values are much higher and comparable total solids, exhibiting the strong effect of the invention of product viscosity.

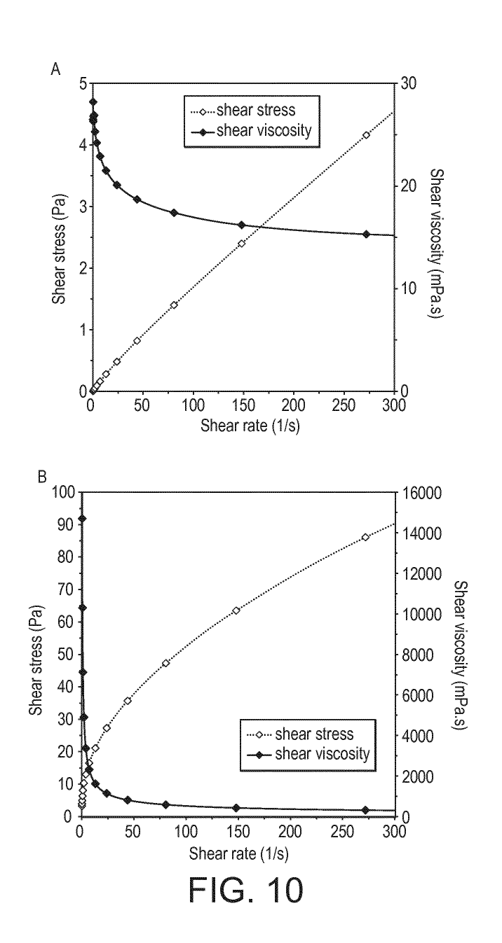

FIG. 11 shows comparative profiling of two samples as described within table 5.

### DETAILED DESCRIPTION

The term “particles having a volume based mean diameter value Dv50” refers to protein network comprising casein micelles and whey proteins either present in aggregates or covalently associated forms. At pH below 6.5 the whey proteins show a strong tendency to form covalent aggregates with the casein micelles.

The term “milk concentrate” that is concentrated above total natural solids. For example commercial full fat milk has around 12.5% total solids, this milk is typically concentration up to 50% total solids by evaporation. The milk may be full-fat milk, skimmed milk or semi-skimmed milk.

The mean diameter value Dv50 of the milk concentrates of the present invention ranges from 1 μm-60 μm. In one embodiment the Dv50 value ranges from 2 μm-25 μm. In another embodiment the Dv50 value ranges from 3 μm-20 μm. In yet another embodiment the Dv50 value ranges from 5 μm-10 μm.

The present invention also relates to a process for preparing a milk concentrate comprising the steps of: a) Providing a liquid milk concentrate at temperature below 25° C.; b) Adjusting pH between 5.7 and 6.4; c) Heat treating the composition at 80-150° C. for 3-300 seconds so that the milk concentrate comprises particles having a mean diameter value Dv50 of at least 1 μm as measured by laser diffraction. The mean diameter Dv50 may range from 5 μm-60 μm. The mean diameter Dv50 may also range from 5 μm-10 μm d) Cooling the composition below 70° C. preferably below 60° C.

In another aspect, the present invention relates to above process followed by further step of readjusting the pH of the composition obtained from step c or d to a pH ranging above 6.4 to 6.8 and heat treating at UHT conditions or retort the product.

In an embodiment of the present invention, the milk concentrate at total solids of 35% (w/w) exhibits a shear viscosity of at least 1000 mPa·s measured at a shear stress of 10 Pa, a shear viscosity of at least 400 mPa·s measured at a shear rate of 100 l/s and a viscosity ratio between these two conditions of at least 2.0 as determined on flow curves obtained with a rheometer at 20° C.

It has been shown during the experiments leading to this invention that milk concentrates at total solids between 35 to 50% (w/w) exhibited a shear viscosity of at least 1000 mPa·s measured at a shear stress of 10 Pa, a shear viscosity of at least 400 mPa·s measured at a shear rate of 100 l/s and a viscosity ratio between these two conditions of at least 2.0 as determined on flow curves obtained with a rheometer at 20° C. All compositions processed outside the conditions of the invention were not able to fulfill these 3 criteria simultaneously, indicating that the structure formed by the protein complex had a direct influence on the flow behavior of the system, and possibly on its textural properties.

In another aspect, the present invention also relates to a process for preparing a milk concentrate comprising the steps of: a) Providing a liquid milk concentrate at temperature below 25° C.; b) Adjusting pH between 5.7 and 6.4; c) Heat treating the composition at 80-150° C. for 3-300 seconds such that the dairy milk concentrate at total solids of 35% (w/w) exhibits a shear viscosity of at least 1000 mPa·s measured at a shear stress of 10 Pa, a shear viscosity of at least 400 mPa·s measured at a shear rate of 100 l/s and a viscosity ratio between these two conditions of at least 2.0 as determined on flow curves obtained with a rheometer at 20° C.

In one embodiment of the present invention, the milk concentrate is characterized after the retort: d) heat treating the composition at 80-150° C. for 3-300 seconds, readjust the pH to above 6.4 and further UHT or retort the product.

It has surprisingly been found that texture and mouthfeel of milk concentrate is enhanced as a result of an optimized process of preparation including the controlled use of heat and acidic conditions.

These protein aggregates form a network that is suspected of binding water and entrapping fat globules (in case of presence of fat) and increases mix viscosity to create a uniquely smooth, creamy texture that mimics the sensory experience (mouthfeel and creaminess) of full fat products.

In one embodiment of the present invention, the milk concentrate does not include any thickeners and/or stabilisers. Examples of such thickeners include hydrocolloids, e.g. xanthan gum, carrageenans or pectins as well as food grade starches or maltodextrins.

In one embodiment of the present invention the milk concentrate is used to produce read-to-drink beverage.

In another embodiment the milk concentrate of the present invention is used as creamer to be added in preparing tea, coffee or chocolate.

In another embodiment the milk concentrate of the present invention is used for manufacturing culinary sauces or cocoa-malt-beverages.

In another embodiment, the milk concentrate of the present invention is used for manufacturing different beverages based on food service/restaurant systems. Examples could be cappuccino, coffee latte, mocha latte, hot chocolate, etc.

### EXAMPLES

### Example 1

### Reference 1 (Whole Milk)

Raw milk (protein (N×6.38) 3.4%, fat 4.0%, total solids 12.8%) is preheated to 60° C. by a plate heat exchanger and homogenized by a Gaulin 53 KF3 8PSX high pressure homogenizer (250 bars). Subsequently, the homogenized milk is concentrated by a Scheffers 3 effects falling film evaporator (from Scheffers B.V.) to approximately 35% total solids. The milk concentrate is cooled by a plate heat exchanger to 4° C. and pH of homogenized liquid milk concentrate was measured to be 6.5. The composition is preheated again to 60° C. by a plate heat exchanger and subsequently heated to 85° C. by direct steam injection system (self-construction of Nestlé) with a holding time of 15 seconds. After the heat treatment, the milk concentrate is rapidly cooled down by a 3VT460 CREPACO scrape heat exchanger (from APV Invensys Worb) to <10° C.

### Reference 2 (Skimmed Milk)

Skimmed milk (protein (N×6.38) 3.5%, fat 0.1%, total solids 9.4%) is preheated to 60° C. by a plate heat exchanger and homogenized by a Gaulin MC 15 10OTBSX high pressure homogenizer (250 bars). Homogenization is performed in order to have equal processing set-up as compared to whole milk manufacture. Subsequently, the homogenized milk is concentrated by a Scheffers 3 effects falling film evaporator (from Scheffers B.V.) to approximately 49% total solids. The milk concentrate is cooled by a plate heat exchanger to 4° C. and pH of homogenized liquid milk concentrate was measured to be 6.4. The composition is preheated again to 60° C. by a plate heat exchanger and subsequently heated to 85° C. by direct steam injection system (self-construction of Nestlé) with a holding time of 15 seconds. After the heat treatment, the milk concentrate is rapidly cooled down by a 3VT460 CREPACO scrape heat exchanger (from APV Invensys Worb) to <10° C.

Sample 1 of Present Invention (Whole Milk)

Raw milk (protein (N×6.38) 3.4%, fat 4.0%, total solids 12.8%) is preheated to 60° C. by a plate heat exchanger and homogenized by a Gaulin 53 KF3 8PSX high pressure homogenizer (250 bars). Subsequently, the homogenized milk is concentrated by a Scheffers 3 effects falling film evaporator (from Scheffers B.V.) to approximately 35% total solids. The milk concentrate is cooled by a plate heat exchanger to 4° C. and pH adjusted to 6.1 using citric acid. The slightly acidified milk concentrate is preheated again to 60° C. by a plate heat exchanger to 4° C. and subsequently heated to 96° C. by direct steam injection system (self-construction of Nestle) with a holding time of around 100 seconds. After the heat treatment, the milk concentrate is rapidly cooled down by a 3VT460 CREPACO scrape heat exchanger (from APV Invensys Worb) to <10° C.

Sample 2 of Present Invention (Skimmed Milk)

Skimmed milk (protein (N×6.38) 3.5%, fat 0.1%, total solids 9.4%) is preheated to 60° C. by a plate heat exchanger and homogenized by a Gaulin MC 15 10OTBSX high pressure homogenizer (250 bars). Homogenization is performed in order to have equal processing set-up as compared to whole milk manufacture. Subsequently, the homogenized milk is concentrated by a Scheffers 3 effects falling film evaporator (from Scheffers B.V.) to approximately 35% total solids. The milk concentrate is cooled by a plate heat exchanger to 4° C. and pH adjusted to 6.1 using citric acid. The slightly acidified milk concentrate is preheated again to 60° C. by a plate heat exchanger and subsequently heated to 90° C. by direct steam injection system (self-construction of Nestle) with a holding time of 300 seconds. After the heat treatment, the milk concentrate is rapidly cooled down by a 3VT460 CREPACO scrape heat exchanger (from APV Invensys Worb) to <10° C.

Samples 3 to 6 of Present Invention (Whole Milk)

Samples 3 to 6 are produced according to the same procedure, involving: concentration of a commercial whole milk to a variable level of total solid content, adding a variable amount of different acids to reach a specific target pH value in the milk concentrate, standardized heat processing including a direct steam injection step, and spray drying to obtain a functionalized milk powder. The following details apply:

TABLE 1
Characteristics of samples 3 to 6 of the present invention.

| | Total solid | | | |
|---|---|---|---|---|
| | content of whole | | Acid | |
| Sample | milk concentrate | | concentration | Target |
| # | (wt %) | Acid type | (wt %) | pH |
| 3 | 25 | Citric acid | 5 | 6.1 |
| 4 | 37 | Citric acid | 5 | 6.2 |
| 5 | 25 | Hydrochloric acid | 2 | 6.1 |
| 6 | 37 | Phosphoric acid | 5 | 6.2 |

Raw material: Commercially available, pasteurized and microfiltrated, homogenized whole milk (3.5% fat content, Cremo, Le Mont-sur-Lausanne, CH) is concentrated to a total solid content as indicated in the table 1, with a Centritherm® CT1-09 thin film spinning cone evaporator (Flavourtech Inc., AU).

Concentration: The concentration process is done in recirculating batch mode, starting with milk at 4° C. The milk is pumped with a progressing cavity pump, from a buffer tank through a plate heat exchanger set to 40° C. outlet temperature and the Centritherm® CT1-09 evaporator, back into the buffer tank. The milk in the buffer tank thereby gradually increases in solid concentration and temperature. When a critical concentration threshold is reached, the milk is brought to the desired total solids content by a final evaporator pass without remixing, and collected in a separate holding tank. The following process parameters are used: flow rate 100 l/h, evaporator inlet temperature 40° C., evaporator vacuum pressure 40-100 mbar, evaporator steam temperature 90° C. This results in concentrate outlet temperatures of around 35° C., and evaporate flow rates which decrease gradually from about 50 l/h to 30 l/h with increasing milk concentration. High product flow rates around 100 l/h and a stable product inlet temperature of 40° C. are essential to avoid fouling of the milk concentrate on the heat exchange surface of the Centritherm® device.

pH adjustment: The milk concentrate is cooled to 10° C. and its pH adjusted at this temperature with a temperature-compensated pH meter Handylab pH 11 (Schott Instruments, D) to the pH value and with the acid as indicated in table 1, under agitation, step-wise, and avoiding local overconcentration of acid. Typical dilution of the milk concentrate by acidifying is in the order of 1-3% relative, depending on final pH, acid type and concentration. The typical timeframe for pH adjustment of a 40 kg batch is about 15 minutes.

Heat treatment: The cooled, acidified milk concentrate is heat-processed in semi-continuous mode on a commercially available OMVE HT320-20 DSI SSHE pilot plant line (OMVE Netherlands B.V., NL). Processing steps are: preheating in the OMVE tubular heat exchanger to 60° C., direct steam injection to 95° C. outlet temperature, 300 sec hot holding period at 95° C. in the two scraped surface heat exchangers of the OMVE line, connected in series and running at maximum rpm, and subsequent cooling to about 23° C. product outlet temperature the OMVE tubular heat exchanger cooled with ice water. Flowrate is set to 14 l/h to obtain a sum of approximately 300 sec residence time in the scraped surface heat exchanger units. Residence time in the OMVE cooler is about 2 minutes. Residence times are averages from volumetric flow rates and dead volume of line elements (tubular heat exchanger, scraped surface heat exchanger). Clogging of the DSI injector is a critical phenomenon, and the line must be carefully controlled in this respect. No flash evaporation is applied and condensing steam remains entirely in the product.

Sample 7 of Present Invention

Skimmed milk (protein (N×6.38) 3.5%, fat 0.1%, total solids 9.4%) is preheated to 60° C. by a plate heat exchanger and subsequently, the skimmed milk is concentrated by a Scheffers 3 effects falling film evaporator (from Scheffers B.V.) to 45% (w/w) total solids. The milk concentrate is cooled by a plate heat exchanger to 4° C. and pH adjusted to 6.0 using citric acid. The pH adjusted milk concentrate is preheated again to 60° C. by a plate heat exchanger and subsequently heated to 90° C. by direct steam injection system (self-construction of Nestle) with a holding time of 150 seconds. After the heat treatment, the milk concentrate is rapidly cooled down to <10° C. by a 3VT460 CREPACO scrape heat exchanger (from APV Invensys Worb).

### Example 2

Particle Size Distribution in Milk Concentrates

The milk concentrates of the present invention were compared to the above references and were characterized by laser diffraction in order to determine particle size distribution (PSD=Particle Size Distribution)

The size of particles, expressed in micrometers (μm) at 50% of the cumulative distribution was measured using Malvern Mastersizer 2000 (references 1 and 2, samples 1 and 2) or Mastersizer 3000 (samples 3 to 6 of present invention) granulometer (laser diffraction unit, Malvern Instruments, Ltd., UK). Ultra pure and gas free water was prepared using Honeywell water pressure reducer (maximum deionised water pressure: 1 bar) and ERMA water degasser (to reduce the dissolved air in the deionised water).

Dispersion of the concentrated milk was achieved in distilled or deionised water and measurements of the particle size distribution by laser diffraction.

Measurement settings used are a refractive index of 1.46 for fat droplets and 1.33 for water at absorption of 0.01. All samples were measured at an obscuration rate of 2.0-2.5%.

The measurement results are calculated in the Malvern software based on the Mie theory (Table 2).

TABLE 2
Average values of Dv50 determined by laser granulometry for samples 3
to 6 of the present invention.

| Sample # | Dv50 (μm) |
|---|---|
| 3 | 6.9 |
| 4 | 11.2 |
| 5 | 59.8 |
| 6 | 10.8 |

Microstructure of the Milk Concentrates

The microstructure of the systems was investigated directly in liquid milk concentrates using light microscopy.

For investigation of liquid samples, a Leica DMR light microscope coupled with a Leica DFC 495 camera was used. The systems were observed using the differential interference contrast (DIC) mode. An aliquot of 500 microliters of liquid sample was deposited on a glass slide and covered with a clover slide before observation under the microscope.

Flow Behavior of the Samples of Invention 1 and 2

Full fat milk or skim milk concentrates were characterized for their flow using a Haake RheoStress 6000 rheometer coupled with temperature controller UMTC-TM-PE-P regulating to 20+/−0.1° C. The measuring geometry was a plate-plate system with a 60 mm diameter and a measuring gap of 1 mm.

The flow curve was obtained by applying a controlled shear stress to a 3 mL sample in order to cover a shear rate range between 0 and 300 l/s (controlled rate linear increase) in 180 seconds.

TABLE 3
Rheological properties determined at 20° C. for full fat milk concentrates at 35%
(w/w) total solids.

| reference 1 | reference 1 | | sample 1 | sample 1 | |
|---|---|---|---|---|---|
| shear | shear | | shear | shear | |
| viscosity at a | viscosity at a | reference 1 | viscosity at a | viscosity at a | |
| shear stress | shear rate of | viscosity | shear stress | shear rate of | sample 1 |
| of 10 Pa | 100 1/s | ratio | of 10 Pa | 100 1/s | viscosity ratio |
| na | 16.9 | / | 11791 | 983 | 11.9 |

na: values were not reached.

From the flow curves, the shear viscosities corresponding to a stress of 10 Pa and a shear rate of 100 l/s were determined. As well, the viscosity ratio from the two conditions was calculated and all data are reported in tables 3 and 4.

TABLE 4
Rheological properties determined at 20° C. for skim milk concentrates at 50% (w/w)
total solids.

| reference 2 | reference 2 | | | sample 2 | |
|---|---|---|---|---|---|
| shear | shear | | sample 2 | shear | |
| viscosity at a | viscosity at a | reference 2 | shear | viscosity at a | sample 2 |
| shear stress | shear rate of | viscosity | viscosity at a | shear rate of | viscosity |
| of 10 Pa | 100 1/s | ratio | stress of 10 Pa | 100 1/s | ratio |
| 167 | 109 | 1.5 | 13059 | 3355 | 3.9 |

Flow Behavior of the Samples of the Invention 3 to 6

Whole milk concentrates without application of the invention (whole milk concentrate 13, 25 and 37% (w/w)) and samples 3 to 6 according to the invention were characterized for their flow using a Controlled-stress Rheometer MCR-502 coupled with a Peltier cell type P-PTD200/56 regulated at 20+/−0.1° C. (Anton Paar). The measuring geometry was plate-plate (smooth surface) type PP50 with a 50 mm diameter and a measuring gap of 1 mm. The flow curve was obtained by applying a controlled shear stress to a 3 mL sample in order to cover a shear rate range between 0 and 300 l/s (controlled rate linear increase) in 180 seconds.

### Example 3

Sensory Characteristics—Fat Reduction

The panelists were given following samples as described in table 5 below.

TABLE 5
Amount of concentrates used for sensory test

| Reference 1 | Sample 9 of invention |
|---|---|
| 12% of milk TS end | 12% of milk TS end cup |
| cup | |

Sample preparation for 1 L final beverage was 343 g concentrate (reference 1) or 267 g concentrate (sample 9), 5 g buffer salts, 36 g sugar filled up to 1 L by tapped water.

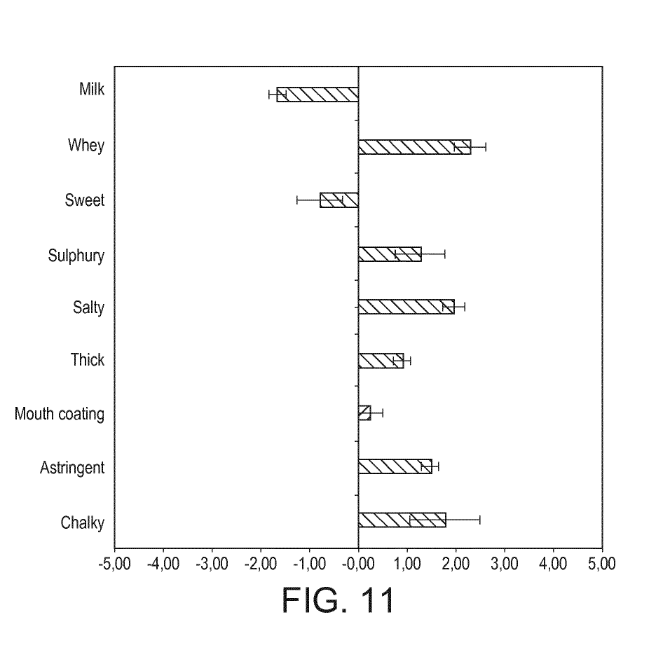

The serving temperature was 40° C. The professional panelists (15) were asked for a comparative profiling of reference 1 to sample 9 of present invention. The results are shown in FIG. 11. Sample of invention shows no significant difference in mouthcoating and a slight increase of thickness in comparison to the reference 1. The difference in whey and milk note is coming from the absence of fat. Anova 90% confidence level.

1. A milk concentrate comprising caseins and whey proteins in the ratio of 90:10 to 60:40, wherein the caseins/whey protein aggregates have a volume based mean diameter value Dv50 of at least 1 μm as measured by laser diffraction.

2. The milk concentrate of claim 1, wherein the volume based mean diameter value ranges from 1 μm-60 μm.

3. The milk concentrate of claim 1, wherein the volume based mean diameter value ranges from 5-10 μm.

4. A process for preparing a milk concentrate of claim 1, comprising the steps of:
a) providing a liquid milk concentrate at temperature below 25° C.;
b) adjusting pH between 5.7 and 6.4;
c) heat treating the composition at 80-150° C. for 3 to 300 seconds so that the milk concentrate comprises particles having a mean diameter value Dv50 of at least 1 μm as measured by laser diffraction the mean diameter Dv50 ranges from 1 μm-60 μm; and
d) cooling the composition below 70° C. preferably below 60° C.

5. A process of claim 4, comprising further the steps of:
readjusting the pH of the composition obtained from step c or d to a pH ranging above 6.4 to 6.8 and heat treating at UHT conditions or retort the product.

6. The milk concentrate of the claim 1, wherein the milk concentrate at total solids of 35% (w/w) exhibits a shear viscosity of at least 1000 mPa·s measured at a shear stress of 10 Pa, a shear viscosity of at least 400 mPa·s measured at a shear rate of 100 l/s and a viscosity ratio between these two conditions of at least 2.0 as determined on flow curves obtained with a rheometer at 20° C.

7. The milk concentrate of claim 6 comprising semi-skimmed, skimmed and/or whole milk.

8. A method comprising a milk concentrate comprising caseins and whey proteins in the ratio of 90:10 to 60:40, wherein the caseins/whey protein aggregates have a volume based mean diameter value Dv50 of at least 1 μm as measured by laser diffraction to produce such a product comprising using the milk concentrate for producing a ready-to-drink beverage, culinary sauces and concentrated milk products.

9. The method of claim 8 wherein the product is produced in a beverage system.
